(19) United States
(12) Patent Application Publication
(10) Pub. No.: US 2014/0327333 A1
(43) Pub. Date: Nov. 6, 2014

(54) BRUSHLESS ELECTROMAGNETIC MOTOR

(71) Applicant: Chan-Peng CHENG, Kaohsiung City (TW)

(72) Inventor: Chan-Peng CHENG, Kaohsiung City (TW)

(73) Assignee: Codent Technical Industry Co., Ltd., Kaohsiung City (TW)

(21) Appl. No.: 13/874,831

(22) Filed: May 1, 2013

(51) Int. Cl. H02K 1/17

(52) U.S. Cl. CPC H02K 1/17
USPC 310/154.03

(57) ABSTRACT

A brushless electromagnetic motor, preferably for use in dental handpieces, has a rotor set, a stator set, a plug set, a magnet, a motor cover kit and a motor end cap. The magnet is fixedly fitted in an interior space between said plug and said rotor. After connection of said rotor and said plug, said stator which grasps said rotor was covered by the motor cover kit, linking said motor end cap. By virtue of 360 degrees of magnetic attraction between said magnet and said rotor, said rotor can be maintained in the same horizontal rotation during operation, in case of vibration due to the centrifugal force caused by the rotation of the rotor, therefore enhancing the mass balance of said rotor, improving eccentricity, consequently increasing the balance of motor, decreasing vibration of the dental handpieces and improving both life span of dental handpieces and bearings of the motor.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

A brushless electric motor is provided in the present invention, particularly a brushless electromagnetic motor for driving dental handpieces, which increase the balance of the motor, decrease vibration of dental handpieces and improve both life span of dental handpieces and bearings of the motor.

2. Description of Related Art Including Information Disclosed Under 37 CFR 1.97 and 37 CFR 1.98.

The conventional brushless electronic motor generally consists of a rotor and stator. The static stator is the main source of a magnetic field around. On the other hand, the rotor is rotatable, constituted by a rotating shall and magnetic materials surrounding the shaft. The magnetic materials can be a permanent magnet as the source of materials. The construction of a static stator is stacked with a plurality of silicon steel and cod apparatus, which surrounds the rotating rotor, Therefore, a magnetic field is generated after electricity is activated through the static stator, which can drive the rotation of the rotor.

In the industry of dental handpieces, electricity-driven motor are the trend. The brushless electric motor is the key technology. Many dentistry-related industries and researchers have explored the efficiency of motor operation. Within there are some analysis in issue 74 and issue 438 of motor newsletter pertaining to vibration and noise generated from motor operation. Those depict the cause of motor noise, which comes from motor vibration, deriving from the motor itself, The vibration noise of the motor results from, for instance, imbalanced or eccentric rotors, and structure of bearings which is worn out.

Combining the view of development and research of motor currently, how to create an invention to improve mass balance of rotor and eccentricity, and consequently increase the balance of motor, decrease vibration of dental handpieces and improve both life span of dental handpieces and bearings of the motor is a crucially indispensable resolution.

### BRIEF SUMMARY OF THE INVENTION

In view of the lack of development among foregoing industrial techniques, one purpose o f the present invention is to provide a brushless electromagnetic motor to improve the mass balance of the rotor and eccentricity.

Another purpose of the present invention is to provide a brushless electromagnetic, motor to increase the balance of motor.

Another purpose of the present invention is to provide a brushless electromagnetic motor to decrease the vibration of dental handpieces.

Another purpose of the present invention is to provide a brushless electromagnetic motor to increase the life span of bearings of the motor.

The present invention relates to a brushless electromagnetic motor, which has a stator set comprising a stator covering a coil apparatus which in cylindrically hollow shape. A rotor set is cylindrically elongated and engaged in said coil apparatus of said stator set. A motor cover kit covers said stator set. A motor end cap connects said motor cover kit. A plug set is provided comprising a motor top cap and a coil cap to link said rotor. A magnet is located in the space between said plug set and said rotor set and is tightly fixed inside said plug set. Within said magnet is annularly fixed within the space which between said plug set and said rotor set after the connection of these two pans. More precisely, within said rotor is under a fixed fork-type element which could drive brushless electromagnetic motor.

### BRIEF DESCRIPTION OF THE SEVERAL VIEWS OF THE DRAWINGS

The invention is described below with reference to the drawing on the basis of preferred embodiment examples.

FIG. 1 shows a preferred embodiment of the present invention brushless electromagnetic motor in an explored view.

FIG. 2 shows a cross-sectional view of the present invention brushless electromagnetic motor.

### DETAILED DESCRIPTION OF THE INVENTION

The present invention relates to a instruments for a medical or a dental motor, especially a brushless electromagnetic motor.

In order to provide more detailed descriptions for inspection process, the following instruction of the preferred embodiments is offered for references, which immensely simplify the assembly thereof and show a variety of advantages and benefits for the progression of brushless electromagnetic motor.

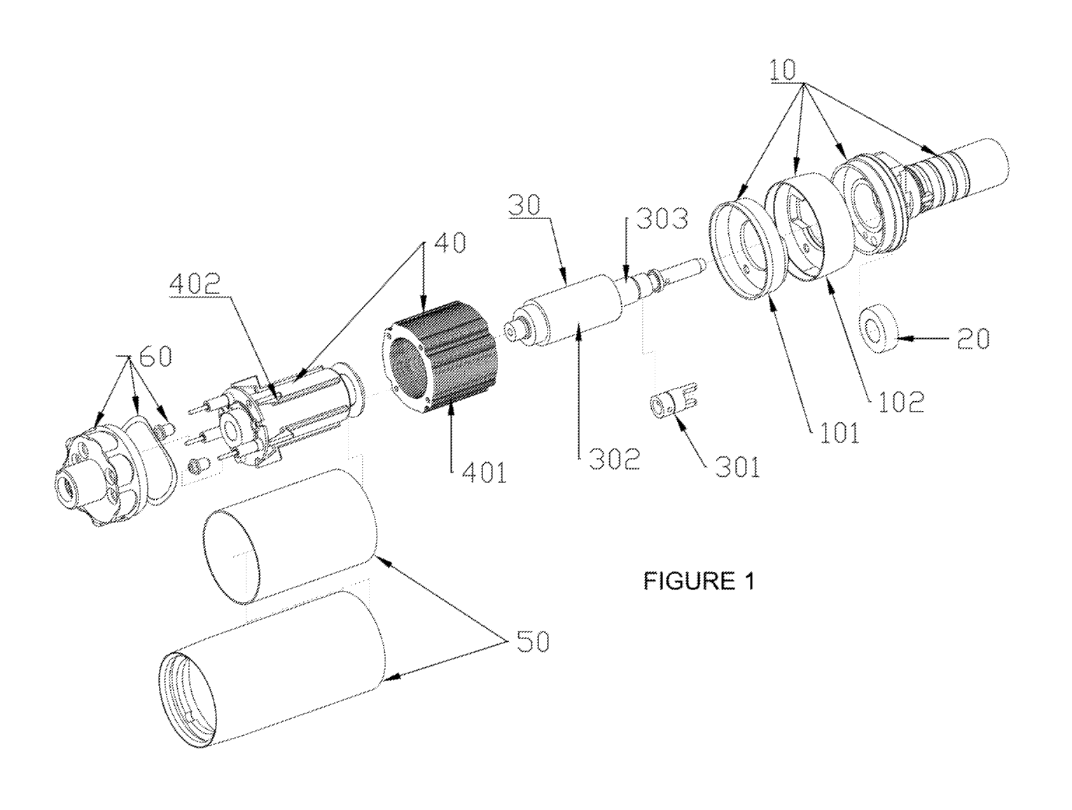

As shown in FIG. 1, a preferred embodiment of the present invention brushless electromagnetic motor in an explored view. It includes a stator set 40 comprising a stator 401 covering a coil apparatus 402 which in cylindrically hollow shape throughout a rotor set 30. Moreover, said rotor set 30 is cylindrically elongated and constituted by a rotor shaft 303 covered by a permanent magnet 302 and engaged in said coil apparatus 402 of said stator set 40. Said rotor shaft 303 is under a fixed fork-type element 301 which could drive the present invention brushless electromagnetic motor.

Besides, a motor cover kit 50 covers said stator set 40. A motor end cap 60 connects said motor cover kit 50. Also, a plug set 10 comprises a motor top cap 102 and a coil cap 101 which link said motor top cap 102 before the connection between said plug set 10 and said rotor set 30.

Furthermore, within a magnet 20 is located in the space between said plug set 10 and said rotor set 30 and tightly fixed inside said plug set 10.

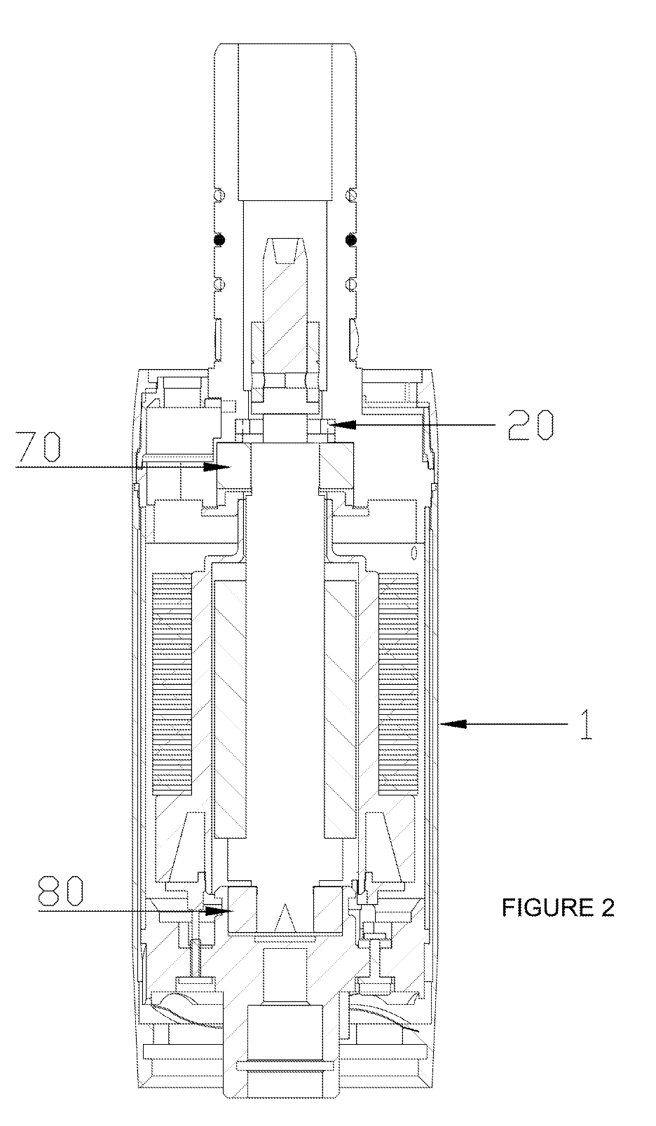

As shown in FIG. 2, there are an above bearing and a below bearing inside the motor. Compared to the prior techniques, within said magnet 20 fixed within said plug set 10 could take the advantage by virtue of 360 degrees magnetic attraction between said magnet 20 and said rotor set 30. Accordingly, said rotor set 30 can be maintained in the same horizontal rotation during operation, in case of vibration due to the centrifugal force caused by the rotation of said rotor set 30.

The present invention possesses the characteristics of novelty, progression, and industrial use, which literally abide by the regulations of patent applications. Overall, the present invention relates to a brushless electromagnetic motor, which has a rotor set, a stator set, a plug set, a magnet, a motor cover kit and a motor end cap. The said magnet is fixedly fitted in an interior space between said plug and said rotor. After connection of said rotor and said plug, said stator which grasps said rotor. was covered by a motor cover kit, linking said motor end cap. By virtue of 360 degrees magnetic attraction between said magnet and said rotor, said rotor can be maintained in the same horizontal rotation during operation, in case of vibration due to the centrifugal force caused by the rotation of the rotor, therefore enhancing said rotor, improving eccentricity, consequently increasing the balance of motor, decreasing vibration of the dental handpieces and improving both life span of dental handpieces and bearings of the motor.

The features disclosed in the above description may be significant to the implementation of the various refinements of the invention both individually and in any given combination thereof.

1. A brushless electromagnetic motor comprising;
a stator set comprising a stator covering a coil apparatus which is in a cylindrically hollow shape;
a rotor set being cylindrically elongated and engaged in said coil apparatus of said stator set;
a motor cover kit covering said stator set;
a motor end cap connecting said motor cover kit;
a plug set comprising a motor top cap and a coil cap to link said rotor; and
wherein a magnet is located in the space between said plug set and said rotor set and tightly fixed inside said plug set.

2. A brushless electromagnetic motor as claimed in claim 1, wherein said magnet is annularly fixed within the space between said plug set and said rotor set after the connection of these two parts.

3. A brushless electromagnetic motor as claimed in claim 1, wherein said rotor is under a fixed fork-type element which could drive the brushes electromagnetic motor.
